(19) United States
(12) Patent Application Publication
(10) Pub. No.: US 2023/0141160 A1
(43) Pub. Date: May 11, 2023

(54) SYSTEMS AND METHODS FOR APPLICATION PROGRAMMING INTERFACE ANALYSIS

(71) Applicant: FRM LLC, Boston, MA (US)

(72) Inventor: Vaideeswaran Prabhakar, Boxborough, MA (US)

(21) Appl. No.: 17/524,400

(22) Filed: Nov. 11, 2021

(51) Int. Cl. G06F 11/30; G06F 21/62

(52) U.S. Cl. CPC G06F 11/3093; G06F 11/302; G06F 21/6218; G06F 2221/2141

(57) ABSTRACT

Systems and methods for analyzing and identifying applications using a crawler. The method includes receiving first data from an application registry and second data from an application image store. The method also includes identifying a first set of candidate applications based on the first data and identifying a second set of candidate applications based on the second data. The method further includes storing the first set of candidate applications and the second set of candidate applications in a database. The method also includes generating for display on a user interface a first list of the first set of candidate application and a second list of the second set of candidate applications. The method further includes receiving third data from a user via the user interface and identifying a third set of candidate applications based on the first data and the third data.

### TECHNICAL FIELD

The present invention relates generally to systems and methods for analyzing software applications, including systems and methods for analyzing and identifying software applications using a crawler.

### BACKGROUND

Most medium and large enterprise computing environments rely on a wide variety of software applications to provide the necessary functionality to internal users and/or external customers. Due to the variation in technical infrastructure, hosting environments, non-functional requirements, and dependencies of such software applications, many organizations have turned to the implementation of application programming interfaces (APIs) as a flexible and efficient method for integrating software applications together into a cohesive framework of functionality.

However, every software application may not be a candidate for conversion or integration into an API paradigm. In many cases, certain software applications may be hosted and/or developed internally while other applications may be hosted externally. In addition, some applications may be managed by external vendors. Furthermore, internally-developed applications may host and/or expose multiple services—which may result in a monolith-type application that may be more effectively implemented if broken down into a plurality of micro services. Finally, certain applications may have other functional and/or non-functional requirements like traffic management, monitoring, security access and the like. All of these application characteristics can have a critical effect on whether software applications can be considered as viable candidates for API development and/or conversion.

### SUMMARY

Accordingly, an object of the invention is to provide systems and methods for analyzing and identifying software applications as candidates for API adoption using an automated crawler that receives application-specific data from a plurality of data sources, including an application repository and an application image store, and analyzes the data to generate one or more lists of candidate applications that can be reviewed to determine which application(s) may be potentially integrated into an API framework. The techniques described herein beneficially enable the rapid and efficient identification of software applications that may be suitable for API development and delivery using programmatic logic implemented in one or more computing devices. The methods and systems advantageously enable product managers and software developers to focus on creating or enhancing API functionality for software applications that can benefit from such efforts.

The invention, in one aspect, features a computerized method for analyzing and identifying applications using a crawler. A server computing device receives first data from an application registry and second data from an application image store corresponding to a plurality of applications. The server computing device identifies a first set of candidate applications of the plurality of applications based on the first data. The server computing device identifies a second set of candidate applications of the plurality of applications based on the second data. The server computing device stores the first set of candidate applications and the second set of candidate applications in a database. The server computing device generates for display on a user interface a first list of the first set of candidate applications and a second list of the second set of candidate applications. The server computing device receives third data from a user via the user interface. The server computing device identifies a third set of candidate applications of the plurality of applications based on the first data and the third data.

The invention, in another aspect, features a system for analyzing and identifying applications using a crawler. The system comprises a server computing device communicatively coupled to a user device and a database over a network. The server computing device receives first data from an application registry and second data from an application image store corresponding to a plurality of applications. The server computing device identifies a first set of candidate applications of the plurality of applications based on the first data. The server computing device identifies a second set of candidate applications of the plurality of applications based on the second data. The server computing device stores the first set of candidate applications and the second set of candidate applications in the database. The server computing device generates for display on a user interface a first list of the first set of candidate applications and a second list of the second set of candidate applications. The server computing device receives third data from a user via the user interface. The server computing device identifies a third set of candidate applications of the plurality of applications based on the first data and the third data.

Any of the above aspects can include one or more of the following features. In some embodiments, the server computing device identifies a fourth set of candidate applications of the plurality of applications based on the second data and the third data, and generates for display on the user interface a third list of the third set of candidate applications and a fourth list of the fourth set of candidate applications. In some embodiments, identifying the first set of candidate applications comprises determining, for each of the applications of the plurality of applications, whether the application is externally hosted and managed by a vendor. In some embodiments, the first set of candidate applications comprises determining, for each of the applications of the plurality of applications, whether the application is managed by a vendor.

In some embodiments, identifying the second set of candidate applications comprises determining, for each of the applications of the plurality of applications, whether the application hosts multiple services. In some embodiments, the user interface retrieves the first set of candidate applications and the second set of candidate applications from the database. In some embodiments, the server computing device is configured to receive a portion of the third data from the application registry corresponding to the plurality of applications. In some embodiments, the third data comprises traffic management characteristics. In some embodiments, the third data comprises application monitoring requirements. In some embodiments, the third data comprises security access requirements.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of an exemplary data communications network, according to embodiments of the technology described herein.

FIG. 2 is a block diagram of an exemplary server computing device and an exemplary user device, according to embodiments of the technology described herein.

FIG. 3 is a block diagram of an exemplary system for analyzing and identifying applications using a crawler, according to embodiments of the technology described herein.

FIG. 4 is a flow diagram of a computerized method of analyzing and identifying applications using a crawler, according to embodiments of the technology described herein.

FIG. 5 is a diagram of an exemplary user interface generated by user interface module of server computing device for display.

FIG. 6 comprises exemplary programmatic logic used by application crawler of server computing device.

### DETAILED DESCRIPTION

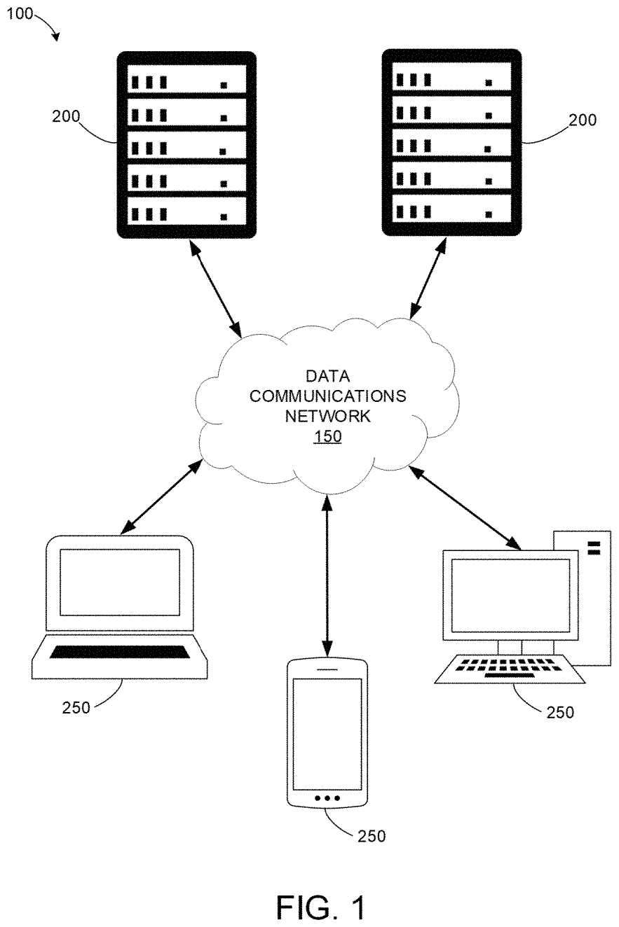

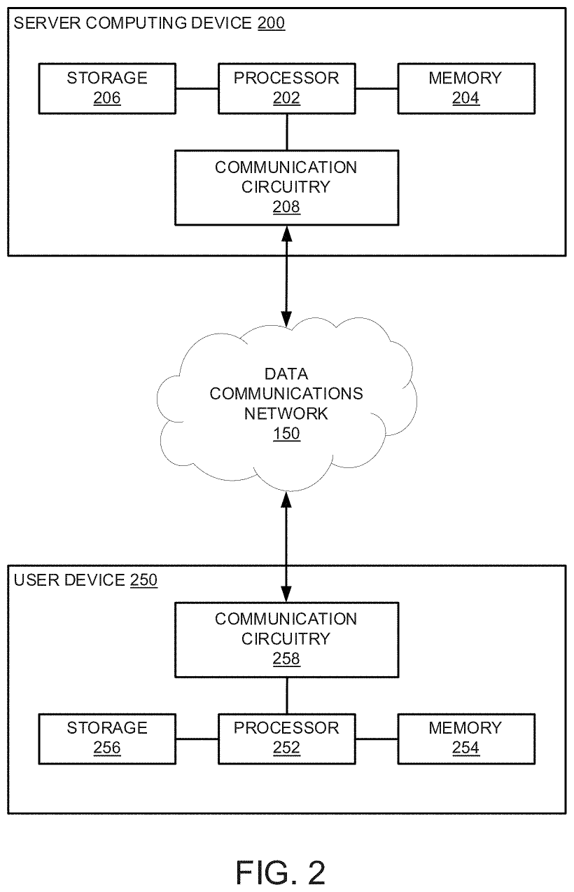

The systems and methods described herein can be implemented using a data communications network, server computing devices, and mobile devices. For example, referring to FIGS. 1 and 2, an exemplary communications system 100 includes data communications network 150, exemplary server computing devices 200, and exemplary user devices 250. In some embodiments, the system 100 includes one or more server computing devices 200 and one or more user devices 250. Each server computing device 200 can include a processor 202, memory 204, storage 206, and communication circuitry 208. Each user device 250 can include a processor 252, memory 254, storage 256, and communication circuitry 258. In some embodiments, communication circuitry 208 of the server computing devices 200 is communicatively coupled to the communication circuitry 258 of the user devices 250 via data communications network 150. Communication circuitry 208 and communication circuitry 258 can use Bluetooth, Wi-Fi, or any comparable data transfer connection. The user devices 250 can include personal workstations, laptops, tablets, mobile devices, or any other comparable device.

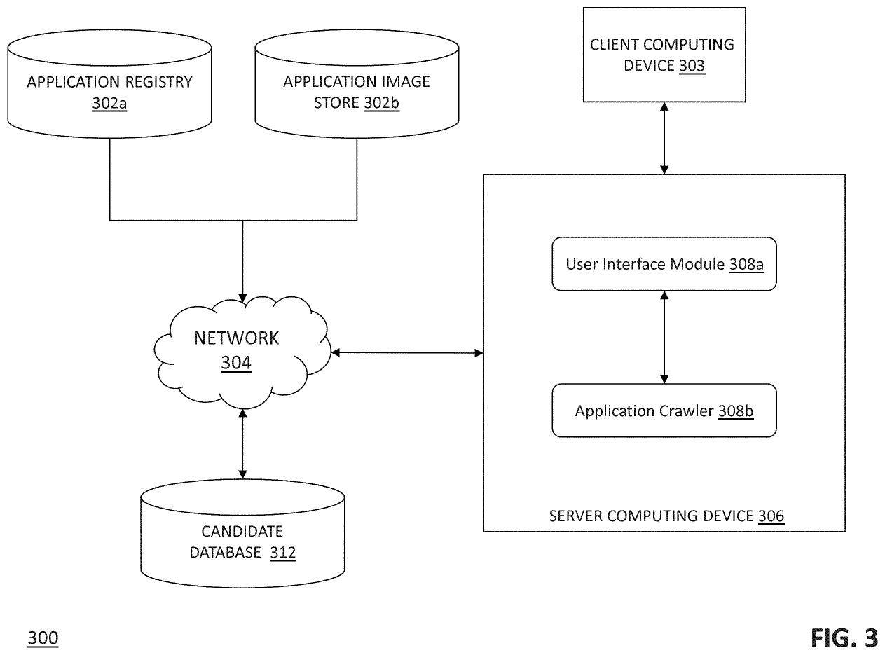

FIG. 3 is a block diagram of an exemplary system 300 for analyzing and identifying applications using a crawler, according to embodiments of the technology described herein. As can be appreciated, system 300 can comprise any or all of the devices and/or components described above with respect to FIGS. 1 and 2.

As shown in FIG. 3, system 300 comprises application registry 302a, application image store 302b, client computing device 303, communications network 304, server computing device 306 that includes user interface module 308a and application crawler 308b, and candidate database 312. In some embodiments, application registry 302a, application image store 302b, and/or candidate database 312 are located on one or more server computing devices that are communicably coupled to server computing device 306 via communications network 304.

As will be explained in greater detail below, application registry 302a, application image store 302b, and candidate database 312 are each configured to receive, generate, and store specific segments of data relating to the process of analyzing and identifying applications using a crawler as described herein. In some embodiments, all or a portion of application registry 302a, application image store 302b, and candidate database 312 can be integrated with the server computing device 306 or be located on a separate computing device or devices. In some embodiments, one or more of application registry 302a, application image store 302b, and candidate database 312 are located in a cloud storage infrastructure comprising one or more nodes accessible by server computing device 306.

Application registry 302a includes data relating to one or more applications that may be deployed in a production computing environment, such as an enterprise computing system that provides application functionality to internal and/or external users. In some embodiments, application registry 302a includes a dedicated section that contains specialized data used by the other components of the system 300 to perform at least a portion of the process of analyzing and identifying applications using a crawler as described herein. Generally, application registry 302a comprises data and metadata associated with one or more applications, including but not limited to application hosting information—such as whether an application is hosted internally or externally and/or whether the application is managed by a vendor. An exemplary application registry that can be used with system 300 is the Now™ platform available from ServiceNow, Inc. of Santa Clara, Calif. (www.servicenow.com).

Application image store 302b includes data relating to one or more applications that may be deployed in a production computing environment, such as an enterprise computing system that provides application functionality to internal and/or external users. In some embodiments, application image store 302b includes a dedicated section that contains specialized data used by the other components of the system 300 to perform at least a portion of the process of analyzing and identifying applications using a crawler as described herein. Generally, application image store 302b comprises data and metadata associated with one or more applications, including but not limited to data corresponding to application binaries, libraries, images, and dependencies. As can be appreciated, an application can be considered ‘monolithic’—meaning that it hosts and/or exposes multiple services and thus it may be desirable to break down the application into micro services in order to provide a more flexible and adaptive technology infrastructure. As such, application image store 302b can comprise data relating to whether the application hosts and/or exposes multiple services. An exemplary application image store 302b that can be used with system 300 is the JFrog™ Artifactory available from JFrog Ltd. of Sunnyvale, Calif. (jfrog.com).

An exemplary client computing device 303 includes but are not limited to desktop computers, laptop computers, tablets, mobile devices, smartphones, smart watches, Internet-of-Things (IoT) devices, and internet appliances. It should be appreciated that other types of computing devices that are capable of connecting to the components of the system 300 can be used without departing from the scope of invention. Although FIG. 3 depicts a single client computing device 303, it should be appreciated that the system 300 can include any number of client computing devices.

Network 304 enables application registry 302a, application image store 302b, candidate database 312 and server computing device 306 to communicate with each other. In some embodiments, client computing device 303 is similarly connected to network 304 in order to communicate with server computing device 306. Network 304 is typically a wide area network, such as the Internet and/or a cellular network. In some embodiments, network 304 is comprised of several discrete networks and/or sub-networks (e.g., cellular to Internet).

In some embodiments, server computing device 306 is a device including specialized hardware and/or software modules that execute on a processor and interact with memory modules, to receive data from other components of the system 300, transmit data to other components of the system 300, and perform functions for analyzing and identifying applications using a crawler as described herein. Server computing device 306 includes several computing modules 308a, 308b that execute on one or more processors of server computing device 306. In some embodiments, modules 308a, 308b are specialized sets of computer software instructions programmed onto one or more dedicated processors in server computing device 306 and can include specifically-designated memory locations and/or registers for executing the specialized computer software instructions.

Although modules 308a, 308b are shown in FIG. 3 as executing within the same server computing device 306, in some embodiments the functionality of modules 308a, 308b can be distributed among a plurality of server computing devices. As shown in FIG. 3, server computing device 306 enables modules 308a, 308b to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. Exemplary functionality of modules 308a, 308b is described in detail below.

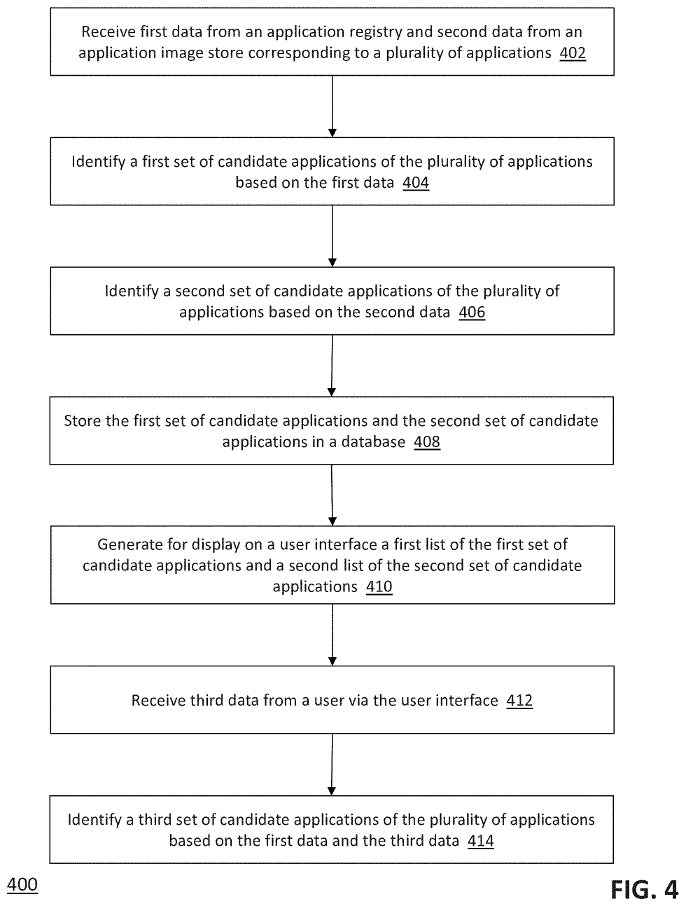

FIG. 4 is a flow diagram of a computerized method 400 of analyzing and identifying applications using a crawler, according to embodiments of the technology described herein. The computerized method 400 of FIG. 4 can be implemented using the system 300 of FIG. 3.

Application crawler 308b of server computing device 306 connects to application registry 302a via network 304 to receive (step 402) first data from application registry 302a that corresponds to a plurality of applications. In some embodiments, application crawler 308b receives data from application registry 302a that is associated with (i) whether one or more of the plurality of applications is externally or internally hosted and/or (ii) whether one or more of the plurality of applications is managed by a vendor. Application crawler 308b generally comprises programmatic logic that analyzes application hosting information stored in application registry 302a and receives the above-referenced data from application registry 302a. Exemplary application hosting information can include, but is not limited to, host address data (e.g., physical and/or logical IP addresses), network connectivity and infrastructure data, server and/or platform identifier(s), host device identifiers, vendor identifiers, and the like.

Application crawler 308b also connects to application image store 302b via network 304 to receive (step 402) second data from application image store 302b that corresponds to a plurality of applications. In some embodiments, application crawler 308b receives data from application image store 302b that is associated with whether one or more of the plurality of applications hosts and/or exposes multiple services. Application crawler 308b generally comprises programmatic logic that analyzes application image information stored in application image store 302b and receives the above-referenced data from application image store 302b. In some embodiments, application image store 302b may not comprise information whereby application crawler 308b can directly determine whether one or more of the plurality of applications hosts and/or exposes multiple services. Instead, in these embodiments application crawler 308b can execute logic that deciphers available information in application image store 302b to understand whether one or more of the plurality of applications hosts and/or exposes multiple services. For example, in an implementation that uses JFrog™ Artifactory as application image store 302b, application crawler 302b can execute the JFrog Xray™ tool (described at jfrog.com/xray) on one or more application images stored in application image store 302b to receive data that is used to determine whether one or more of the plurality of applications hosts and/or exposes multiple services.

When application crawler 308b receives the first data from application registry 302a and the second data from application image store 302b, application crawler 308b identifies (step 404) a first set of candidate applications of the plurality of applications based on the first data and identifies (step 406) a second set of candidate applications of the plurality of applications based on the second data. In some embodiments, application crawler 308b executes programmatic logic on the first data and the second data in a predetermined sequence in order to identify the first set of candidate applications and the second set of candidate applications. For example, as an initial step, application crawler 308b can analyze the first data received from application registry 302a to determine whether one or more of the plurality of applications is hosted internally or externally and whether one or more of the plurality of applications is managed by a vendor. Application crawler 308b identifies applications that are managed by a vendor and that are hosted externally for inclusion in the first set of candidate applications of the plurality of applications.

In some embodiments, between step 402 and step 404, one or more users of client computing device 303 can review the applications in the first set of candidate applications and provide input on certain features, such as non-functional features like traffic management characteristics (e.g., quota, rate limiting), monitoring requirements, security access requirements and the like, of one or more of the applications in the first list. In some embodiments, applications with certain identified non-functional features can be removed or pruned from the first set of candidate applications.

Then, for applications that are not included in the first set of candidate applications, application crawler 308b can analyze the second data received from application image store 302b to determine whether one or more of the applications hosts and/or exposes multiple services. Application crawler 308b identifies applications that host and/or expose multiple services for inclusion in the second set of candidate applications of the plurality of applications.

When application crawler 308b generates the first set of candidate applications and the second set of candidate applications as described above, application crawler 308b stores (step 408) the first set of candidate applications and the second set of candidate applications in candidate database 312. In some embodiments, application crawler 308b can supplement data associated with the first set of candidate applications and/or the second set of candidate applications with additional information from application repository 302a—such as authentication method(s) used by the candidate applications and/or other non-functional requirements of the candidate applications—for use in generating the user interface as described below.

User interface module 308a of server computing device 306 generates (step 410) for display on a user interface a first list of the first set of candidate applications and a second list of the second set of candidate applications. In some embodiments, user interface module 308a generates a user interface comprising the first list and the second list and communicates the user interface to client computing device 303 for display to one or more users. As can be appreciated, client computing device 303 can comprise or be coupled to a display screen (not shown) that renders and displays the user interface. One or more users at client computing device 303 can view the first list of the first set of candidate applications and the second list of the second set of candidate applications and provide input relating to aspects or features of one or more applications in the first list and/or the second list. As mentioned above, in some embodiments one or more users of client computing device 303 can review the applications in the first list and/or the second list and provide input on certain features, such as non-functional features like traffic management characteristics (e.g., quota, rate limiting), monitoring requirements, security access requirements and the like, of one or more of the applications in the first list and/or the second list. As mentioned above, application crawler 308b can supplement the requirements with data received from application repository 308a (e.g., authentication methods, security access requirements) and display the data to a user of client computing device 303. It should be appreciated that in some embodiments user interface module 308a can be located on client computing device 303, such that application crawler 308b provides data that enables client computing device 303 to generate the user interface locally.

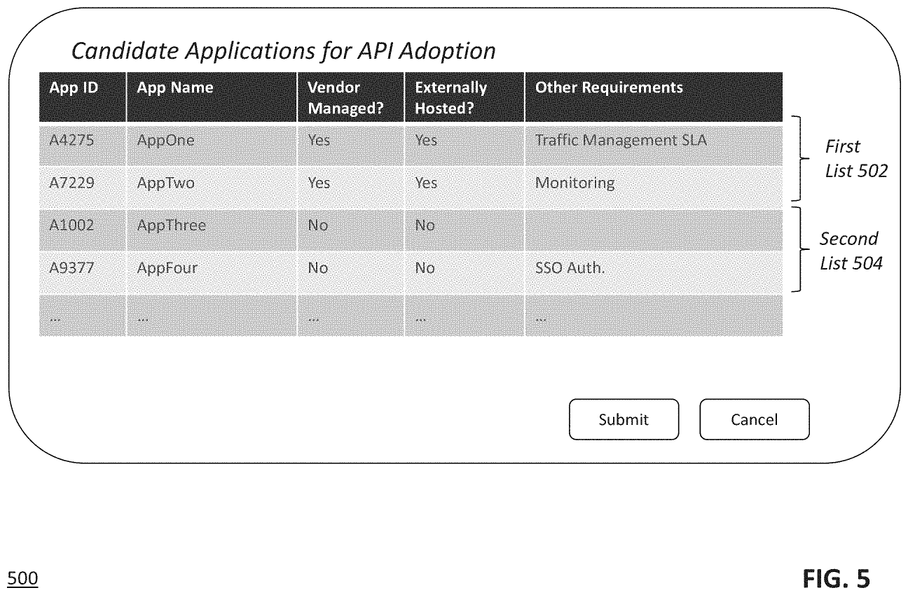

FIG. 5 is a diagram of an exemplary user interface 500 generated by user interface module 308a of server computing device 306 for display on client computing device 303. User interface 500 includes a table comprised of first list 502 and second list 504, wherein first list 502 includes the first set of candidate applications of the plurality of applications as determined by application crawler 308a using the first data, and second list 504 includes the second set of candidate applications of the plurality of applications as determined by application crawler 308a using the second data. A user at client computing device 303 can provide input relating to other functional or non-functional requirements of one or more applications in first list 502. For example, a user can indicate that application A4275 requires traffic management service-level architecture (SLA) (e.g., by typing into the Other Requirements field for that application, by selecting from a drop-down menu, etc.). When the user interacts with the submit button, client computing device 303 transmits the user input to application crawler 308b of server computing device 306.

Application crawler 308b receives (step 412) the above-referenced input provided by the one or more users of client computing device 303 as third data. Application crawler 308b identifies (step 412) a third set of candidate applications of the plurality of applications based on the first data and the third data. For example, certain applications may be considered as candidates for application programming interface integration and/or adoption only when (i) the applications are vendor-managed and externally hosted (as determined using the first data) and (ii) the applications have certain non-functional requirements (as determined using the third data). In one example, as mentioned above a non-functional requirement can be when the application requires traffic management service-level architecture (SLA). One or more users at client computing device 303 can indicate that one or more applications in the first set of candidate applications requires traffic management SLA and provide that indication as third data to application crawler 308b. Application crawler 308b then uses the third data to identify a third set of candidate applications based on the first data and the third data.

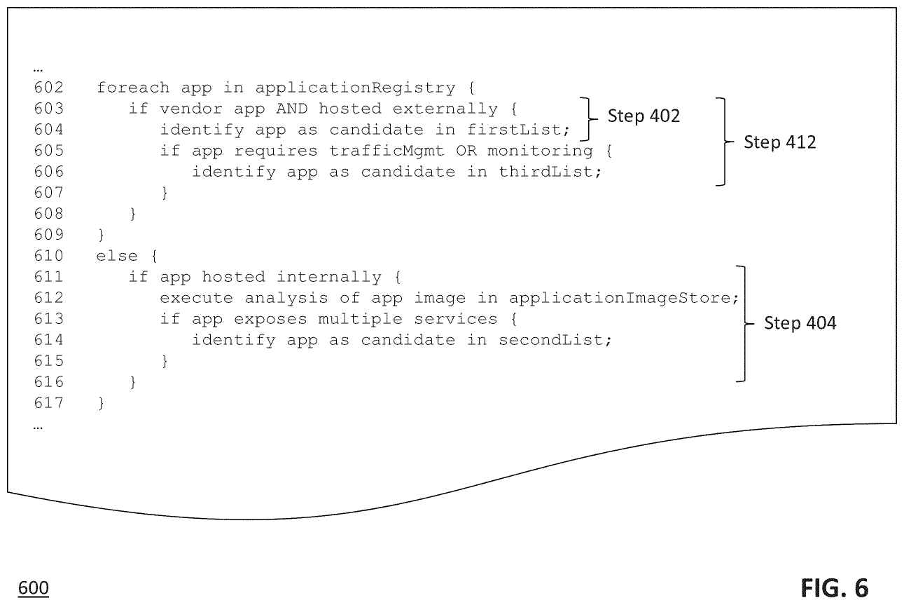

FIG. 6 comprises exemplary programmatic logic 600 used by application crawler 308b to perform steps 404, 406, and 412 of FIG. 4. As shown in FIG. 6, application crawler 308b executes lines 602 to 604 to identify a first set of candidate applications of the plurality of applications based on the first data (e.g.., whether the application is managed by a vendor and hosted externally or internally, as received from application registry 302a)—which corresponds to step 404 of FIG. 4. With the first set of candidate applications, application crawler 308b executes lines 605 to 607 to analyze the third data received from one or more users via the user interface displayed on client computing device 303 (e.g., traffic management characteristics or monitoring requirements) to identify a third set of candidate applications of the plurality of applications based on the first data and the third data—which corresponds to step 412 of FIG. 4.

For applications that are not identified in the first set of candidate applications or the third set of candidate applications, application crawler 308b executes lines 610 to 616 to identify a second set of candidate applications of the plurality of applications based on the second data (e.g., whether the application hosts and/or exposes multiple services). As mentioned above, in some embodiments application crawler 308b analyzes application images stored in application image store 302b (e.g., using a tool like JFrog Xray) to determine the second data.

In some embodiments, application crawler 308b can identify a fourth set of candidate applications of the plurality of applications based on the second data and fourth data, where the fourth data can comprise (i) input provided by a user of client computing device 303 (e.g., using user interface 500) that relates to functional and/or non-functional requirements of the plurality of applications and/or (ii) data received from application registry 302a that relates to functional and/or non-functional requirements of the plurality of applications. For example, a user at client computing device 303 can provide input into user interface 500 relating to one or more applications in second list 504 and when the user interacts with the submit button, user interface 500 transmits the input to application crawler 308b of server computing device 306 as fourth data. Application crawler 308b can identify a fourth set of candidate applications of the plurality of applications using the second data and the fourth data. For example, application crawler 308b can determine that an application exposes multiple services (using the second data) and that the application has certain requirements (e.g., security access requirements, traffic management requirements, monitoring requirements) using the fourth data, as input by user of client computing device 303 and/or received from application registry 302a. In some embodiments, user interface module 308a can generate for display on the user interface a third list of the third set of candidate applications and a fourth list of the fourth set of candidate applications. For example, a user at client computing device 303 can view the user interface comprising the third list and the fourth list to, e.g., set a product roadmap, schedule delivery of one or more APIs for application(s) in the third list and/or the fourth list, or perform other types of software development activities based upon the information contained in the user interface.

In some embodiments, once a final list of candidate applications of the plurality of applications is generated by application crawler 308b, the final list can be provided to client computing device 303 so that a user at client computing device 303 can validate the final list (e.g., to confirm the final list of candidate applications is complete, accurate, correct, etc.).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for analyzing and identifying applications using a crawler, the method comprising:
receiving, by a server computing device, first data from an application registry and second data from an application image store corresponding to a plurality of applications;
identifying, by the server computing device, a first set of candidate applications of the plurality of applications based on the first data;
identifying, by the server computing device, a second set of candidate applications of the plurality of applications based on the second data;
storing, by the server computing device, the first set of candidate applications and the second set of candidate applications in a database;
generating, by the server computing device, for display on a user interface a first list of the first set of candidate applications and a second list of the second set of candidate applications;
receiving, by the server computing device, third data from a user via the user interface; and
identifying, by the server computing device, a third set of candidate applications of the plurality of applications based on the first data and the third data.

2. The method of claim 1, further comprising:
identifying, by the server computing device, a fourth set of candidate applications of the plurality of applications based on the second data and the third data; and
generating, by the server computing device, for display on the user interface a third list of the third set of candidate applications and a fourth list of the fourth set of candidate applications.

3. The computerized method of claim 1, wherein identifying the first set of candidate applications comprises determining, for each of the applications of the plurality of applications, whether the application is externally hosted and managed by a vendor.

4. The computerized method of claim 1, wherein identifying the first set of candidate applications comprises determining, for each of the applications of the plurality of applications, whether the application is managed by a vendor.

5. The computerized method of claim 1, wherein identifying the second set of candidate applications comprises determining, for each of the applications of the plurality of applications, whether the application hosts multiple services.

6. The computerized method of claim 1, wherein the user interface retrieves the first set of candidate applications and the second set of candidate applications from the database.

7. The computerized method of claim 1, wherein the server computing device is configured to receive a portion of the third data from the application registry corresponding to the plurality of applications.

8. The computerized method of claim 1, wherein the third data comprises traffic management characteristics.

9. The computerized method of claim 1, wherein the third data comprises application monitoring requirements.

10. The computerized method of claim 1, wherein the third data comprises security access requirements.

11. A system for analyzing and identifying applications using a crawler, the system comprising:
a server computing device communicatively coupled to a user device and a database over a network, the server computing device configured to:
receive first data from an application registry and second data from an application image store corresponding to a plurality of applications;
identify a first set of candidate applications of the plurality of applications based on the first data;
identify a second set of candidate applications of the plurality of applications based on the second data;
store the first set of candidate applications and the second set of candidate applications in the database;
generate for display on a user interface a first list of the first set of candidate applications and a second list of the second set of candidate applications;
receive third data from a user via the user interface; and
identify a third set of candidate applications of the plurality of applications based on the first data and the third data.

12. The system of claim 11, wherein the server computing device is configured to:
identify a fourth set of candidate applications of the plurality of applications based on the second data and the third data; and
generate for display on the user interface a third list of the third set of candidate applications and a fourth list of the fourth set of candidate applications.

13. The system of claim 11, wherein identifying the first set of candidate applications comprises determining, for each of the applications of the plurality of applications, whether the application is externally hosted and managed by a vendor.

14. The system of claim 11, wherein identifying the first set of candidate applications comprises determining, for each of the applications of the plurality of applications, whether the application is managed by a vendor.

15. The system of claim 11, wherein identifying the second set of candidate applications comprises determining, for each of the applications of the plurality of applications, whether the application hosts multiple services.

16. The system of claim 11, wherein the user interface retrieves the first set of candidate applications and the second set of candidate applications from the database.

17. The system of claim 11, wherein the server computing device is configured to receive a portion of the third data from the application registry corresponding to the plurality of applications.

18. The system of claim 11, wherein the third data comprises traffic management characteristics.

19. The system of claim 11, wherein the third data comprises application monitoring requirements.

20. The system of claim 11, wherein the third data comprises security access requirements.
